(19) United States
(12) Patent Application Publication
(10) Pub. No.: US 2021/0032152 A1
(43) Pub. Date: Feb. 4, 2021

(54) THERMALLY HARDENED ISOTROPIC GLASS

(71) Applicant: SAINT-GOBAIN GLASS FRANCE, COURBEVOIE (FR)

(72) Inventors: Guillaume KAMINSKI, LINZ (AT); Romain DECOURCELLE, MARGNY LES COMPIEGNE (FR); Francis SERRUYS, BRUGES (BE)

(21) Appl. No.: 16/981,930

(22) PCT Filed: Mar. 26, 2019
(86) PCT No.: PCT/FR2019/050684

§ 371 Date: Sep. 17, 2020

(30) Foreign Application Priority Data
Mar. 27, 2018 (FR) 1852640

(51) Int. Cl. C03B 27/012; C03B 27/04

(52) U.S. Cl. CPC C03B 27/012; C03B 27/0413

(57) ABSTRACT

A process for manufacturing a heat strengthened glass, includes a heat treatment applied to a thermally tempered glass. Moreover, a heat strengthened glass sheet in accordance with standard EN1863-1:2011 has a surface stress of greater than 30 MPa, an edge compressive stress of greater than 30 MPa, a mean optical retardation of less than 40 nm.

The invention relates to the field of heat strengthened glasses, also referred to as semi-toughened glasses, in particular intended for the facades of buildings.

The treatments for thermal tempering of the glass, in particular for thermal toughening or heat strengthening, involve heating at around 615° C. followed by rapid air jet cooling. This is a controlled process that has been used for many years. To do this, the glass is heated in a furnace, in particular a radiation or convection furnace, then cooled by cooling elements (generally referred to as quenching boxes) administering to the glass a plurality of air jets with the aid of nozzles. In most thermal tempering units, the glass is conveyed by rollers and horizontally. After having been heated at a temperature in the vicinity of 615° C., the glass is rapidly cooled using jets of air, the velocity of which is adjusted as a function of the thickness and of the desired stress level in the final glass. This adjustment may in particular be carried out by acting on the pressure in the ducts administering the air impingement jets.

Within the context of the present invention, the expression “thermal tempering” is a general expression encompassing heat strengthening and thermal toughening. The thermal tempering of the glass generates a stress field in the thickness thereof (of parabolic profile) giving it a greater flexural mechanical strength and a specific failure mode, in particular reducing the risk of injury to people in the event of breakage in the case of thermally toughened glass. This stress field is obtained by the differential in cooling rate between the surfaces of the main faces of the glass and the core thereof, during the setting of the glass. The thicker the glass, the less necessary it is to blow strongly in order to generate the residual stress field considering the thermal inertia for cooling the core. To equip buildings, heat strengthened glazings must be in accordance with standard EN1863-1:2011, which requires a minimum 4 point bending strength and a certain fragmentation behavior leading to sufficiently large pieces so that in the event of breakage they remain held in the frame of the glazing and do not fall out. This is a very substantial difference with toughened glass which in the event of breakage explodes into a multitude of small pieces which are not held by the frame. The minimum 4 point bending strength requires a 5% fractile tensile strength of at least 70 MPa, which may be determined in accordance with standard EN1288-3, a standard to which the standard EN1863-1:2011 refers.

The rapid cooling of the thermal tempering treatment is carried out using air jets generally applied simultaneously to both main faces of the glass. The air jets are blown between rollers for conveying the glass sheets. A conveying roller is generally coated with a strip of helical shape generally made of a polymer material, generally made of aromatic polyamide (Kevlar, Nomex, Twaron), occasionally in contact with the glass. These materials are chosen for their very good mechanical properties, in particular their great tensile strength, and thermal properties (practically zero thermal expansion and low thermal conductivity). EP 0 253 525 B1 describes a conveying roller wrapped with a discontinuous strip of insulating material.

The use of air jets does not however make it possible to guarantee a homogeneous cooling over the whole of the glass. The use of glasses with low emissivity layers furthermore makes the control of the furnace much more complex. Specifically, the operation of the furnace requires increasingly fine controls (profile and amount of convection and/or radiation). This results in a greater inhomogeneity of the temperature field of the glass sometimes with temperature gradients of several tens of degrees Celsius over a distance of only a few centimeters when the glass leaves the furnace.

Depending on its thermal history and owing to the birefringence properties of the glass, the refractive index of the glass may vary locally, which may, under polarized light, be expressed by the appearance of iridescences well known to glass workers under the name “quench marks”, this expression also being used for heat strengthened (“semi-toughened”) glass, even if it is not completely toughened. This inhomogeneity of the glass is referred to as anisotropy and may be connected to an inhomogeneous distribution of the stresses within the glass, which depends firstly on the thermal history of the glass, i.e. the homogeneity of its thermal tempering heating and the homogeneity of its thermal tempering cooling.

For a building facade application, insulating glazings comprising a plurality of thermally tempered glass panes are used. Generally, the higher the number of thermally tempered glass panes a glazing comprises, the more visible the quench mark is. These glass panes must be in accordance with standard EN1863-1:2011 combining a minimum flexural strength and a suitable fragmentation behavior, and preferably also a surface stress greater than 30 MPa and an edge stress greater than 20 MPa.

Within the context of the present application, a surface stress is measured by an apparatus operating on the principle of polariscopy such as the Scalp-04 polariscope sold by GlasStress Ltd, the value determined being an arithmetic mean of 5 measurements on a main surface of the glass sheet and at least 20 cm from the edge. The stress values given are absolute values, since a person skilled in the art may also express them with a negative sign.

Within the context of the present application, an edge stress is measured by photoelasticimetry using the Sharples Edge Stress Meter Ref (S-67) device from the company Sharples Stress Engineers.

A person skilled in the art distinguishes thermally toughened glass from heat strengthened glass, also referred to as “semi-toughened” glass. A thermally toughened glass leads to a surface stress of greater than 90 MPa, generally between 90 and 200 MPa. A heat strengthened glass to a surface stress within the range from 30 to 90 MPa, more generally within the range from 30 to 60 MPa.

The manufacture of a heat strengthened glass is carried out on equipment identical to that of thermally toughened glass. The heating conditions are identical but the cooling air blowing power is lower, which reduces convective heat exchanges with the main faces of the glass. Consequently, the cycle time is longer since more time is needed for the cooling to set the residual stresses in the glass. The heat strengthened glass therefore spends much more time in the cooling zone and its thermal history is greatly impacted: the contribution of the conductive heat exchanges between the glass and the rollers, if need be with strips of polymer material, generally made of aromatic polyamide, in particular made of Kevlar, around the rollers, is greater. Generally, during the rapid cooling blowing, the glass is subjected to an oscillation parallel to its main faces, exerted by the rollers. Since the cooling time is longer, the total number of oscillations increases and the number of stops when the rollers change direction during the oscillations increases also. Yet each stop increases the cooling heterogeneities. Specifically, when the glass is stopped (even for a few milliseconds), a surface zone of the glass directly receiving a jet of air is more greatly impacted than a zone located between the jets of air and cooled by conduction and by the jets of air deflected after impact of the glass. The entire surface of the glass is not therefore subjected exactly to the same treatment. An unfavorable configuration is the case of a static thermal tempering during which the glass has not performed any oscillation during the cooling.

It is possible to make a direct connection between the heat exchange coefficients and the photoelastic image of a statically thermally tempered glass. The effect of the air jets is quite clearly demonstrated. It has furthermore been observed that poorly controlled kinematic conditions (speed of transfer from the furnace to the quench boxes, speed of oscillation, amplitude of the oscillations) are factors that potentially worsen the anisotropy of the glass. Analysis of the photoelastic images also makes it possible to highlight the marks due to contact with strips of polymer material equipping the conveying rollers, in particular a sort of grid pattern.

It was observed that the anisotropy of heat strengthened glasses is even more difficult to control than that of toughened glass, especially when the glass is thick.

The heat strengthened glass produced according to the invention is referred to as “final heat strengthened glass”. This final heat strengthened glass was produced by application of a post-heat treatment to a thermally tempered glass that is referred to as “intermediate glass”. This intermediate glass was produced by application of a thermal tempering treatment to a glass that is referred to as “primary glass”. Thus the invention relates to a process for manufacturing a heat strengthened glass, referred to as final heat strengthened glass, comprising a heat treatment referred to as a post-heat treatment, applied to a thermally tempered glass, referred to as intermediate glass, said post-heat treatment leading to the final heat strengthened glass.

According to the invention, the “post-heat treatment” is applied to the intermediate (already thermally tempered) glass for which it is desired to reduce the anisotropy, an undesired source of iridescences visible to the naked eye. This post-heat treatment (“post” meaning to signify “after the thermal tempering” leading to the intermediate glass, which already calls for heating) may be carried out in a drying oven, in particular under static conditions, the sheets of intermediate glass then being stationary in the drying oven. It is possible to place a stand in the drying oven and the sheets of intermediate glass are laid on the stand. The drying oven has the role of applying a heat cycle for the purpose of reducing the anisotropy of the intermediate glass. The structural relaxation of the glass under the effect of temperature has been demonstrated. Specifically, the tempering stress decreases as a function of the time and temperature of the post-treatment. It is estimated that this reduction in the anisotropy is accompanied by a decrease in the mean optical retardation of the glass. Specifically, the lower the mean optical retardation, the lower the dispersion thereof over the whole of the glass. The reduction in the mean optical retardation is considered to be linked to the reduction in the anisotropy.

Within the context of the present application, the mean optical retardation values are determined using a photoelastic bench as described for example in “The effect of optical anisotropies on building glass façades and its measurement methods; Frontiers of Architectural Research (2015) 4, 119-126”, with a resolution of 1.5 mm (each pixel corresponding to a zone on the glass pane of 1.5×1.5 mm), the mean optical retardation being the arithmetic mean of the optical retardations measured for each pixel. Firstly, the mapping of the optical retardations is carried out for the whole of the surface of the glass, which is achieved using an optical device comprising a circular polariscope. This circular polariscope comprises
a source of light, preferably polychromatic light, delivering a light beam in the direction of an optical axis, then successively in the direction of the light beam,
a first circular polarizer comprising a first linear polarizer followed (along the path of the light) by a first quarter-wave plate, polarizing the light in a first direction of rotation, then
an analyzer, which is a second circular polarizer in a second direction of rotation of the polarization opposite to the first direction of rotation, this analyzer comprising a second quarter-wave plate followed (along the path of the light) by a second linear polarizer.

The glass to be analyzed is positioned in the circular polariscope between the first circular polarizer and the analyzer. Downstream of the circular polariscope, an optical sensor provided with a lens delivers a digital image (therefore composed of pixels) of the glass.

The final heat strengthened glass has a surface stress lower than the surface stress of the intermediate glass. In particular, the intermediate glass has a surface stress within the range from 35 to 90 MPa. In particular, the final heat strengthened glass has a surface stress within the range from 30 to 60 MPa.

The final heat strengthened glass has a mean optical retardation lower than the mean optical retardation of the intermediate glass, which is the reason for the quench mark of the final heat strengthened glass being less pronounced to the naked eye and on the outside compared to the intermediate glass.

The greater the temperature and duration of the post-heat treatment, the lower the stresses in the glass. The relatively strong post-heat treatment affects the initial stress of the glass but it has been discovered that it had a positive effect on the anisotropy. Specifically, it would appear that a homogenization of the residual stresses takes place during the post-heat treatment, which might be the reason for a reduction in the quench mark.

The post-heat treatment is carried out at a sufficient temperature and for a sufficient time to substantially reduce the quench mark. This is correlated with a reduction in the mean optical retardation and in the surface stress. The post-heat treatment is however carried out at a temperature and for a duration compatible with the compliance of the final heat strengthened glass with standard EN1863-1:2011. Specifically, the final glass must retain the properties that are expected for a heat strengthened glass for construction. Thus, the post-heat treatment is preferably carried out between a minimum temperature and a maximum temperature. The post-heat treatment is preferably carried out at a temperature above the minimum temperature, which is 250° C. and preferably 270° C. and preferably 280° C. The post-heat treatment is preferably carried out at a temperature below the maximum temperature, which is 550° C. and preferably 500° C., and preferably 480° C. This maximum temperature is below the glass transition temperature of the glass. The higher the post-heat treatment temperature, the shorter its duration. The post-heat treatment preferably comprises heating for at least one hour, in particular between 1.5 and 10 hours, between the minimum temperature and the maximum temperature. After the post-heat treatment, the glass is cooled to ambient temperature, the cooling rate then being of little importance. The post-treatment is applied to the whole of the intermediate glass. The post-treatment is generally carried out in air.

The intermediate glass is a thermally tempered glass. It was produced by thermal tempering of a glass, referred to as primary glass, comprising heating of said primary glass generally to at least 580° C., generally between 580 and 650° C., followed by air jet impingement cooling. The cooling is rapid, its rate generally being between 0.5 and 5° C./sec between the start of the cooling and 500° C., the cooling rate generally being even greater when the glass is thin. This cooling is fast enough for the intermediate glass to have a surface stress within the range from 35 to 90 MPa. The primary glass is conveyed by conveying rollers during the heating and/or cooling leading to the intermediate glass, conveying rollers being wrapped with braids or strips made of polymer material, in particular of aromatic polyamide type, in particular made of Kevlar.

This intermediate glass comprises a quench mark visible to the naked eye in the outside light, which quench mark the invention proposes to reduce. The primary glass (and therefore also the intermediate glass and the final heat strengthened glass) is generally a soda-lime-silica glass that has not generally undergone any particular thermal tempering treatment.

Between the thermal tempering of the primary glass leading to the intermediate glass and the post-heat treatment applied to the intermediate glass, the glass returns to a temperature below 250° C. and generally to ambient temperature, i.e. to less than 50° C., generally between 0 and 50° C.

The glass (primary, intermediate and final) is generally in the form of a sheet having a thickness within the range from 5 to 13 mm, it being possible for the thickness thereof in particular to be 8 or 10 mm. Each main face generally has an area of between 0.05 and 63 m². The glass (primary, intermediate, final heat strengthened) is generally a soda-lime-silica glass. The glass may be curved but is generally flat.

The invention in particular enables the manufacture of a sheet of heat strengthened glass in accordance with standard EN1863-1:2011 and having a surface stress of greater than 30 MPa, an edge compressive stress of greater than 30 MPa, a mean optical retardation of less than 40 nm. In particular, the surface stress may be between 32 and 55 MPa. In particular, the edge compressive stress may be less than 45 MPa.

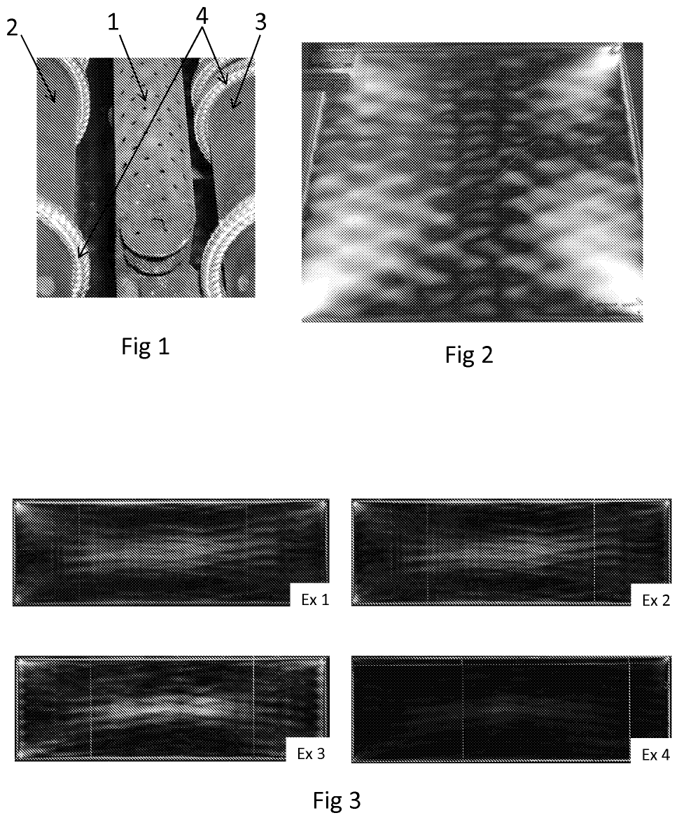

FIG. 1 is a photo showing an air blowing nozzle 1 for administering a thermal tempering cooling, positioned between two rollers 2 and 3 for conveying glass sheets, said rollers being equipped with braids 4 made of Kevlar. It is these braids that come into contact with the glass in order to convey it.

FIG. 2 shows a photo of a sheet of thermally tempered glass (of “intermediate” glass type) displaying the quench mark in a quite pronounced manner and which the invention makes it possible to reduce or even to make disappear. It is estimated that the grid pattern marks are the result of a temperature inhomogeneity of the glass due to the contact thereof with the Kevlar braids shown in FIG. 1. This photo is an image of the glass taken using a circular polariscope in which the glass was placed, the image having been recorded by an optical sensor.

FIG. 3 shows the quench marks of glazings produced according to the examples.

### EXAMPLES

Heat strengthened glass sheets having a thickness of 8 mm and 10 mm were produced, the main faces of which had dimensions of 1100×360 mm. Some of these sheets were then subjected to a post-heat treatment. Next, the following measurements were carried out:
surface stress;
permanent edge compressive stress;
mean optical retardation;
compliance with standard EN1863-1:2011 (including the 4 point bending strength according to standard EN1288-3 and the fragmentation).

Table 1 collates the conditions for carrying out the various tests and the results.

TABLE 1

| | | | Mean optical | Surface | Edge |
|---|---|---|---|---|---|
| Example | | Post-heat | retardation | stress | stress |
| no. | Thickness | treatment | (nm) | (MPa) | (MPa) |
| 1 (comp) | 8 mm | — | 46.8 | 52.4 | 52.8 |
| 2 | 8 mm | 350° C., 4 h | 42.7 | 50.9 | 38.7 |
| 3 (comp) | 10 mm | — | 57.3 | 60.8 | 51 |
| 4 | 10 mm | 450° C., 4 h | 30.8 | 33.6 | 31.9 |

The glass from example 2 corresponds to that of example 1 except that it has additionally undergone a post-heat treatment. The glass from example 4 corresponds to that of example 3 except that it has additionally undergone a post-heat treatment. It is seen that the post-heat treatment results in a reduction in the mean optical retardation. The glasses from all these examples were in accordance with standard EN1863-1:2011.

Images were furthermore produced representing the quench mark of each of these glazings from their mapping of optical retardations. These images were produced using a circular polariscope in which the glass was placed, the image having been recorded by an optical sensor. These images are visible in FIG. 3. It is seen that the post-heat treatment (ex 2 and ex 4) has indeed reduced the quench mark compared to the same glazings that have not undergone the post-heat treatment (ex 1 to be compared with ex 2; ex 3 to be compared with ex 4).

1. A process for manufacturing a heat strengthened glass, referred to as final heat strengthened glass, comprising a heat treatment referred to as a post-heat treatment, applied to a thermally tempered glass, referred to as intermediate glass, leading to the final heat strengthened glass.

2. The process as claimed in claim 1, wherein the final heat strengthened glass has a surface stress lower than a surface stress of the intermediate glass.

3. The process as claimed in claim 2, wherein the final heat strengthened glass has a surface stress within the range from 30 to 60 MPa.

4. The process as claimed in claim 1, wherein the intermediate glass has a surface stress within the range from 35 to 90 MPa.

5. The process as claimed in claim 1, wherein the post-heat treatment is carried out at a temperature above a minimum temperature, said minimum temperature being 250° C.

6. The process as claimed in claim 5, wherein the post-heat treatment is carried out at a temperature below a maximum temperature, said maximum temperature being 550° C.

7. The process as claimed in claim 6, wherein the post-heat treatment comprises heating for at least one hour between the minimum temperature and the maximum temperature.

8. The process as claimed in claim 1, wherein the glass is a sheet having a thickness within the range from 5 to 13 mm.

9. The process as claimed in claim 1, wherein the post-heat treatment is carried out in a drying oven.

10. The process as claimed in claim 1, wherein the intermediate glass was produced by thermal tempering of a glass, referred to as primary glass, comprising heating said primary glass to at least 580° C. followed by air jet impingement cooling.

11. The process as claimed in claim 10, wherein the primary glass is conveyed by conveying rollers during the heating and/or the cooling.

12. The process as claimed in claim 11, wherein the conveying rollers are wrapped with braids or strips made of polymer material.

13. The process as claimed in claim 1, wherein the intermediate glass is a soda-lime-silica glass.

14. A heat strengthened glass sheet in accordance with standard EN1863-1:2011 having a surface stress of greater than 30 MPa, an edge compressive stress of greater than 30 MPa, a mean optical retardation of less than 40 nm.

15. The sheet as claimed in claim 14, wherein the surface stress is between 32 and 55 MPa.

16. The sheet as claimed in claim 14, wherein the edge compressive stress is less than 45 MPa.

17. The sheet as claimed in claim 14, wherein a thickness thereof is within the range from 5 to 13 mm.

18. The sheet as claimed in claim 14, wherein the sheet is made of soda-lime-silica glass.

19. The process as claimed in claim 5, wherein the minimum temperature is 280° C.

20. The process as claimed in claim 6, wherein the maximum temperature is 480° C.
